(19) United States
(12) Patent Application Publication
(10) Pub. No.: US 2010/0077792 A1
(43) Pub. Date: Apr. 1, 2010

(54) ELECTROSTATIC LUBRICANT AND METHODS OF USE

(75) Inventor: Michael H. Gurin, Glenview, IL (US)

Correspondence Address: MICHAEL H. GURIN, 4132 COVE LANE, UNIT A, GLENVIEW, IL, 60025, US

(73) Assignee: REXORCE THERMIONICS, INC., Akron, OH (US)

(21) Appl. No.: 12/239,811

(22) Filed: Sep. 28, 2008

(51) Int. Cl. F25B 43/02; B05B 5/00; F16C 32/06; G05B 15/00; C10M 169/04

(52) U.S. Cl. 62/470; 239/690; 384/100; 700/275; 508/110

(57) ABSTRACT

An integrated thermodynamic system for enhancing the energy efficiency and operating lifetime by reducing wear of moving parts is provided. The system provides automated means to attract or repel electrically conductive or magnetic lubricants in a dynamic manner. The system, when utilizing advanced lubricants including ionic liquids, poly(ionic) liquids, electrorheological fluids, or expanded fluid; and a control system implementing dynamic algorithms, preferably meets the complex demands of thermodynamic systems, particularly high speed rotating equipment, for obtaining high efficiency that requires low friction and long lifetimes that requires superior wear resistance.

### FIELD OF THE INVENTION

Lubricants and lubricant control systems consisting of electrostatic or electromagnetic devices within thermodynamic cycles for air conditioning, refrigeration, or power generating systems.

### BACKGROUND

Various embodiments relate to operable modes for generating power, cooling, or heating utilizing a wide range of thermodynamic cycles from Rankine, Brayton, to Goswami cycles to optimize the energy efficiency associated with the power production or consumption, and to increase the operating lifetimes of the components with moving parts by reducing friction. Many such known methods are present in the art ranging from magnetic bearings to gas bearings, though virtually all of these methods are subject to limited number of start/stop cycles. Additional more traditional methods ranging from oil bearings utilizing traditional lubricants have other limitations ranging from temperature to adverse impact of heat transfer within a thermodynamic cycle's heat exchangers.

A lubricant system that overcomes the cost, lifetime, or efficiency limitations as noted would be of great utility for many high value applications in both power generation, and traditional heating/air conditioning and refrigeration applications. One such exemplary would be a turboexpander capable of having a virtually unlimited number of start/stop cycles through the use of either an electrostatic or electromagnetic method to switch between modes of attracting or repelling an lubricant, and more preferably a lubricant capable of partially absorbing the thermodynamic cycle working fluid.

The term “algorithm” refers to calculations, rules, and parameter values utilized to determine the change of state in a deterministic manner.

The term “hydraulic” energy refers to the utilization of a pressurized fluid, which is generally incompressible, to store and/or transmit power.

The term “thermal hydraulic” fluid refers to the utilization of a pressurized fluid, which generally has increasing pressure at increasing temperatures. A thermal hydraulic fluid is a compressible fluid, with one exemplary being supercritical CO2. Another example is a binary fluid whereby CO2 is absorbed into the absorbent.

The term “supercritical” is defined as the point at which fluids have been exploited above their critical temperatures and pressures.

The term “expanded fluid” refers to a binary composition comprised of a gas, such as carbon dioxide, and a solvent or absorbent in which the gas is respectively dissolved or absorbed that has an increasing volume for increasing temperatures at a specified pressure. The term “ionic liquids” “ILs” is defined as liquids that are highly solvating, non-coordinating medium in which a variety of organic and inorganic solutes are able to dissolve. They are effective solvents for a variety of compounds, and their lack of a measurable vapor pressure makes them a desirable substitute for Volatile Organic Compounds (VOCs). Ionic liquids are attractive solvents as they are non-volatile, non-flammable, have a high thermal stability, and are relatively inexpensive to manufacture. The key point about ionic liquids is that they are liquid salts, which means they consist of a salt that exists in the liquid phase and have to be manufactured; they are not simply salts dissolved in liquid. Usually one or both of the ions is particularly large and the cation has a low degree of symmetry. These factors result in ionic liquids having a reduced lattice energy and hence lower melting points. Exemplary ionic liquids include liquid ionic phosphates “LIPs”, polyammonium ionic liquid sulfonamides “PILS”, poly(ionic liquids), or combinations thereof, with the additional distinct advantage of being more tolerant to moisture content (above 2%).

The term “poly(ionic) liquid” refers to polymer of ionic liquid monomers.

The term “thermodynamic cycle” is defined as a process in which a working fluid undergoes a series of state changes and finally returns to its initial state, in which the state changes are within a low pressure first state relative to a second high pressure state. The high pressure state is upstream of either an expansion valve or expander device, and the low pressure state is upstream to a compressor or pump. The low pressure first state is at a temperature that is lower than the high pressure second state. Any reference to high pressure is understood as being at a higher pressure of a high side state point relative in the context of a thermodynamic cycle to a low side state point.

The term “separation device” is a device that separates at least one component from another using methods known in the art including filtration, electrostatic attraction or repulsion, or electromagnetic attraction or repulsion.

The term “thermodynamic device” is a device having moving parts within a system having a thermodynamic cycle. Such devices include pump, compressor, turbine, turboexpander, positive displacement pumps and motors, piston pumps and motors, where the thermodynamic device either increases the pressure of the thermodynamic working fluid or extracts mechanical energy from the thermodynamic working fluid.

The term “thermodynamic system” is a system that operates a thermodynamic cycle and has at least one thermodynamic device, and at least one heat exchanger for the addition of thermal energy, and at least one heat exchanger for the removal of thermal energy.

The term “friction reducing device” is a device operable to reduce the friction between moving parts as known in the art to include gas bearings, magnetic bearings, journal bearings, etc.

The term “partially desorb” refers to a minimum of 5% on a weight basis of the total weight absorbed or solubilized thermodynamic working fluid from the solvent or absorbent.

The term “electrorheological” is in the context of an electrorheological fluid where the fluid's viscosity changes when subjected to an electrical field.

The term “dry running friction” is the friction between moving parts when the moving parts are operating without any lubricant.

The term “operating speed” is the actual operational speed for the thermodynamic within the device specifications, and more particularly the upper limit of the speed specification.

The term “moving surfaces” is at least two surfaces that have physical contact with each other and that move in relation to each other. The movement between each other can include rotational or sliding between the at least two surfaces.

Various embodiments of the present invention relate to energy generation, and more particularly to power generation employing dynamic switching to an array of energy storage devices having unique prioritization and energy demand profiles.

Additional embodiments may further include the means to utilize byproduct waste heat in a manner that enables the asynchronous utilization and production of the primary energy form and thermal energy.

Additional features and advantages of the various embodiments are described herein and will be apparent from the detailed description of the presently preferred embodiments. It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

### SUMMARY

A high efficiency and long operating lifetime, thermodynamic cycle device is provided. The process uses the combination of a primary working fluid with at least a partially immiscible lubricant having either electrically conductive or magnetic properties with a method of controlling the attraction or repelling of the lubricant from the surface of a moving part within the thermodynamic cycle device. The further incorporation of a control system increases the energy efficiency and operating lifetime, especially in thermodynamic cycles having high frequency start/stop operations, as it creates a substantial amount of friction and wear on moving/rotating parts within the thermodynamic cycle devices including compressors, pumps, and expanders.

One aspect of various embodiments is to dynamically vary between two modes of operating, which are lubricant attraction and repulsion, as a means of increasing energy efficiency and reducing friction.

Another aspect of various embodiments is to utilize the immiscible lubricant having either electrically conductive or magnetic properties in combination with a nanofiltration membrane to seal and prevent the flow of a thermodynamic cycle working fluid passed the nanofiltration membrane.

### BRIEF DESCRIPTION OF DRAWINGS

FIG. 1 is a schematic diagram depicting a traditional electrostatic fluid injection system.

FIG. 2 is a schematic diagram depicting a thermodynamic cycle with a downstream electrostatic fluid separator of each thermodynamic device having friction from moving parts.

FIG. 3 is a schematic diagram depicting a thermodynamic cycle with a control system switching the polarity of an electrostatic field between attraction and repulsion modes.

FIG. 4 is a schematic diagram depicting a thermodynamic cycle with a working fluid being regulated by an electrically conductive lubricant contained within a nanofiltration device.

FIG. 5 is a schematic diagram depicting rolling parts having polarity switching zones to alternate between lubricant attraction and repulsion.

FIG. 6 is a schematic diagram depicting the use of a weak solution from an absorption heat pump for expansion device lubricity.

FIG. 7 is a schematic diagram depicting a combination fluid inlet and discharge port in the inlet mode.

FIG. 8 is a schematic diagram depicting a combination fluid inlet and discharge port in the discharge mode.

FIG. 9 is a schematic diagram depicting the use of a strong solution from an absorption heat pump for pump device lubricity.

FIG. 10 is a schematic diagram depicting the use of high pressure working fluid to create hydrostatic forces prior to equilibrium operation.

### DETAILED DESCRIPTION OF THE PREFERRED EMBODIMENTS

Friction from moving parts present opportunities and challenges that are distinct for most thermodynamic cycle energy consumers and energy producers. The first and most important distinction is compatibility of the thermodynamic cycle working fluid with the lubricant of choice. The second is adverse impact that a lubricant has on heat transfer within the thermodynamic cycle heat exchangers due to the lubricant creating a barrier film within the heat exchangers therefore reducing the heat exchanger effectiveness. Another challenge for lubricants is the operating conditions particularly within an energy producer cycle where the combination of high temperatures and the presence of supercritical working fluids such as carbon dioxide solubilize the lubricant which prevents the lubricant from forming a hydrodynamic film, which renders the lubricant virtually worthless. The selection of superior lubricants, and the ability to precisely control the lubricant attraction or repulsion reduces the associated energy inefficiencies thus contributing to lower emissions, operating costs, and maintenance costs. These benefits further reduce the hurdles particularly for turbines or turboexpanders that are now limited to relatively few start/stop cycles, which leads to more opportunities for distributed generation, hybrid vehicles, and high efficiency HVAC/R.

One embodiment of the electrostatic or electromagnetic lubricant invention provides for the integration of a polarity switching mechanism and control system to optimize the performance of a thermodynamic cycle for high efficiency and long operating lifetimes.

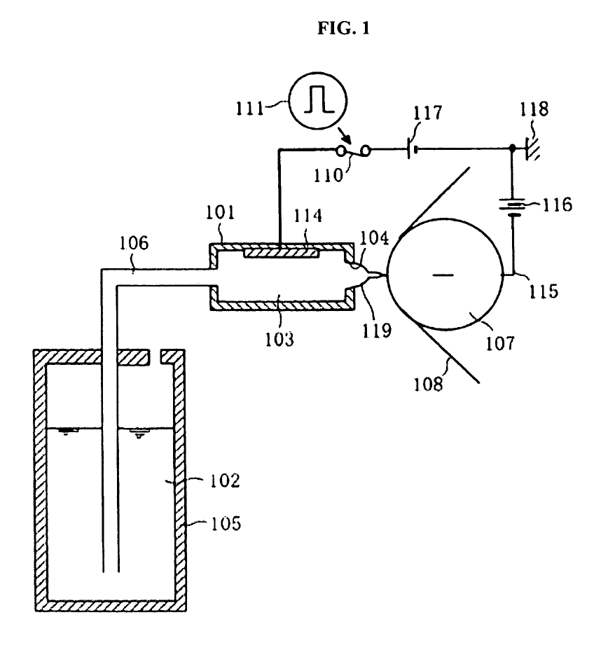

Referring to FIG. 1, a general depiction of an electrostatic field for fluid attraction is depicted, with the polarity reversing to achieve fluid repulsion. Reference numeral 101 indicates a lubricant charge accumulator, reference numeral 102 indicates lubricant, reference numeral 103 indicates a lubricant charge accumulator, reference numeral 104 indicates a nozzle hole, reference numeral 105 indicates a lubricant accumulator, reference numeral 106 indicates a lubricant supplying path, reference numeral 107 indicates a rotating roller which is an exemplary moving part, reference numeral 108 indicates a hydrodynamic film created by the lubricant, reference numeral 110 indicates a control element portion, and reference numeral 111 indicates a process control portion.

Further, reference numeral 114 indicates an electrostatic field applying electrode portion which is provided in the lubricant charge accumulator 103 of the lubricant charge accumulator 101, reference numeral 115 indicates a counter electrode portion which is a electrically conductive component of at the rotating roller 107, and reference numeral 116 indicates a bias power supply portion for applying a negative voltage to the counter electrode portion 115. Reference numeral 117 indicates a voltage power supply portion for supplying a voltage to the electrostatic field applying electrode portion 114, and reference numeral 118 indicates a ground portion.

Here, between the electrostatic field applying electrode portion 114 and the counter electrode portion 115, the negative voltage applied from the bias power supply portion 116 to the counter electrode portion 115 and a voltage of from the power supply portion 117 are superimposed. In this way, a superimposed electric field is generated. The ejection of the lubricant 102 ejected from the nozzle hole 104 is controlled by means of the superimposed electric field. In addition, reference numeral 119 indicates a projected meniscus that is formed at the nozzle hole 104 by the bias voltage applied to the counter electrode portion 115. The rotating roller 107 is representative of a moving surface of a compressor, pump, or expander.

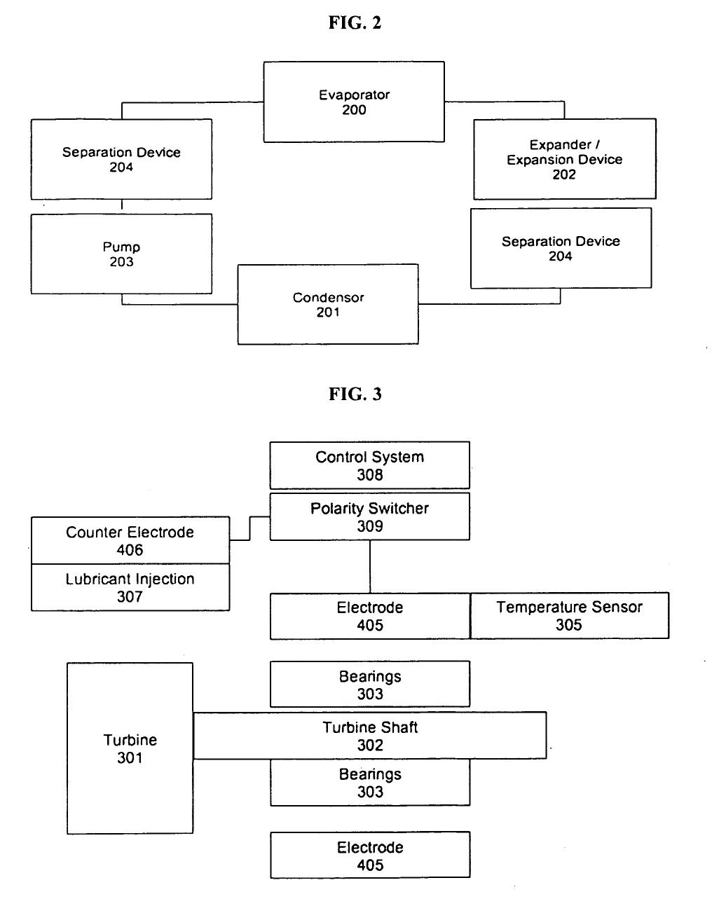

Referring to FIG. 2, a general depiction of a basic Rankine thermodynamic cycle utilizing an electrically conductive lubricant, such that the electrically conductive lubricant is controlled to switch between being attracted to the surfaces of the friction producing moving parts within thermodynamic devices having moving parts including an expander 202, which can be thermodynamic devices ranging from gerotor motor, positive displacement motor, to turbine, and a pump 203 ranging from gerotor pump, other positive displacement pumps, to scroll compressors. The critical element is the respective downstream placement of a separation device 204, which includes electrostatic filters, electrostatic nanofiltration membranes, to a simple configuration of electrodes and counter electrodes, relative to the expander 202 and/or pump 203.

Referring to FIG. 3, a depiction of an expansion device being a turbine 301 having a control system 308 capable of performing all operations of the turbine particularly including the turbine start and stop control procedures. The control system 308 has a series of inputs and outputs that enable the voltage polarity of each electrode 405 and counter electrode 406 to be switched using a polarity switcher 309. The polarity switcher 309 in most operations will maintain a constant polarity to the lubricant injection 307 device such that the lubricant will be preferably atomized for superior attraction, as known in the art, to the electrically conductive turbine shaft 302. The control system 308 will also regulate the flow of lubricant through the lubricant injection 307 device such that the lubricant is predominantly present within the turbine shaft during start/stop periods when the turbine is not rotating fast enough to achieve the benefits of bearings, which are preferably gas bearings or magnetic bearings 303. The control system can utilize numerous sensors or other inputs to determine how the turbine 301 operates, with one preferred exemplary being a temperature sensor 305 in thermal communication with the electrode (though other placements are anticipated) as a method to determine the real-time lubricant temperature. The control system 308 will switch between the lubricant attraction mode and lubricant repulsion mode for many reasons including: a) lubricant temperature is reaching the maximum lubricant threshold temperature thus enabling the hot lubricant to be replaced by a “slug” of cold lubricant; b) turbine has reached sufficient operating speed to enable sufficient benefit of the gas and/or magnetic bearings (the invention anticipates other contact free methods to eliminate or greatly reduce friction between moving parts) such that lubricant is no longer necessary and in fact the presence of lubricant will surpass the maximum lubricant operating temperature due to the presence of high temperature working fluids from the thermodynamic cycle; c) turbine is approaching a real-time speed at which the gas and/or magnetic bearings are no longer reducing the friction between moving parts sufficiently.

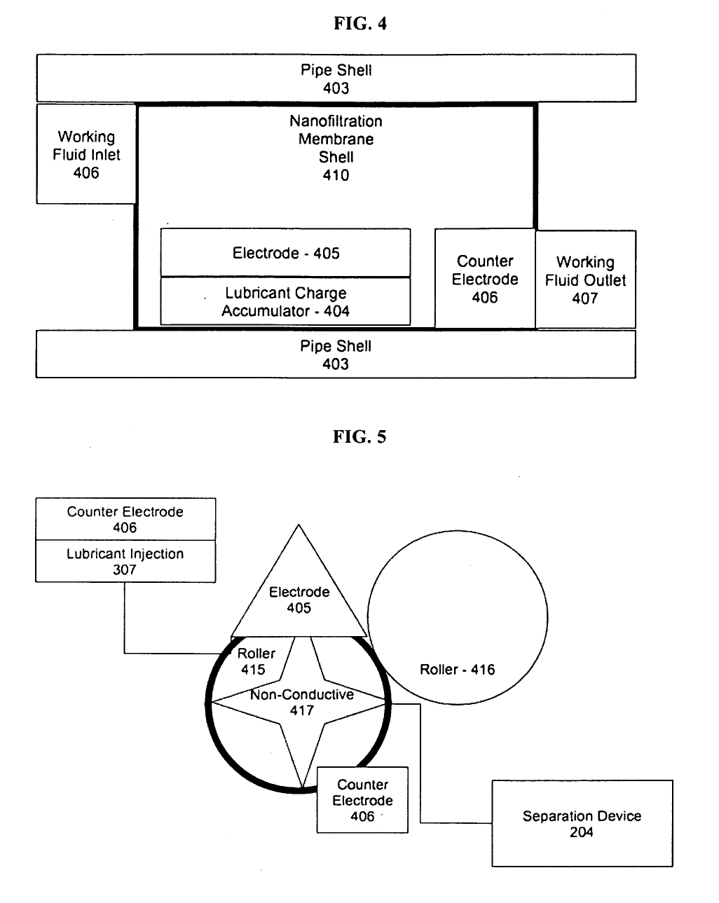

Referring to FIG. 4 is a depiction of an electrostatically or electromagnetically controlled seal and/or valve through the utilization of an electrically conductive and/or magnetic lubricant contained within nanofiltration membrane shell 410. The nanofiltration membrane 410, as known in the art, is designed to prevent the leakage of the lubricant (at least less than 10% on a weight basis of the total lubricant weight within the seal/valve) by having a pore size smaller than the lubricant molecular size though larger than the thermodynamic working fluid molecular size. The nanofiltration membrane 410 is fixed within a pipe shell 403 such that both the working fluid and the lubricant can not leak past the nanofiltration membrane. The thermodynamic working fluid enters the pipe shell 403 through the working fluid inlet 406 and exits, after passing through the nanofiltration membrane when the lubricant via control of the counter electrode 406 does not prevent passage, through the working fluid outlet 407. A control system, as depicted in earlier figures, regulates the voltage and polarity to both the electrode 405 and counter electrode 406 to control working fluid flow as well as the charge of the lubricant through the lubricant charge accumulator 404.

Referring to FIG. 5 is a depiction of a rolling device having contact between two surfaces where the rolling device has at least one electrostatically charged roller 415 and at least one grounded roller 416 in which the utilization of an electrostatic field enables the attraction of a charged lubricant to be infused, preferably atomized through a lubricant injection device 307 having obtained a charge from the counter electrode 406. The electrostatically charged roller 415 is broken into roller regions, with one exemplary design being a non-conductive barrier 417 between each roller region. Numerous methods are anticipated in this invention to create roller regions including: a) use of a non-conductive or non-magnetic roller substrate with selective electroplating and/or electroforming to make alternating regions that are electrically conductive and non-electrically conductive; or b) use of a conductive substrate broken into multiple regions and subsequently connected to each other w/ a non-conductive material. The conductive roller 415 is in electrical communication with an electrode 405 such that the electrode 405 charges at least one roller region in order to electrostatically attract the lubricant and such that at least one region of the roller 415 is in contact with the counter electrode 406 such that the lubricant is repelled from the roller 415 surface. The thick line on the roller 415 indicates the creation of a hydrodynamic film created by the electrostatically attracted lubricant. The presence of that hydrodynamic film will predominantly on the roller 415 surfaces in electrical communication with the electrode 405. Once the lubricant is repelled from the roller 415 surface by the counter electrode 406, the thermodynamic working fluid and the lubricant flow to the separation device 204 that will then effectively isolate the lubricant from the working fluid as known in the art.

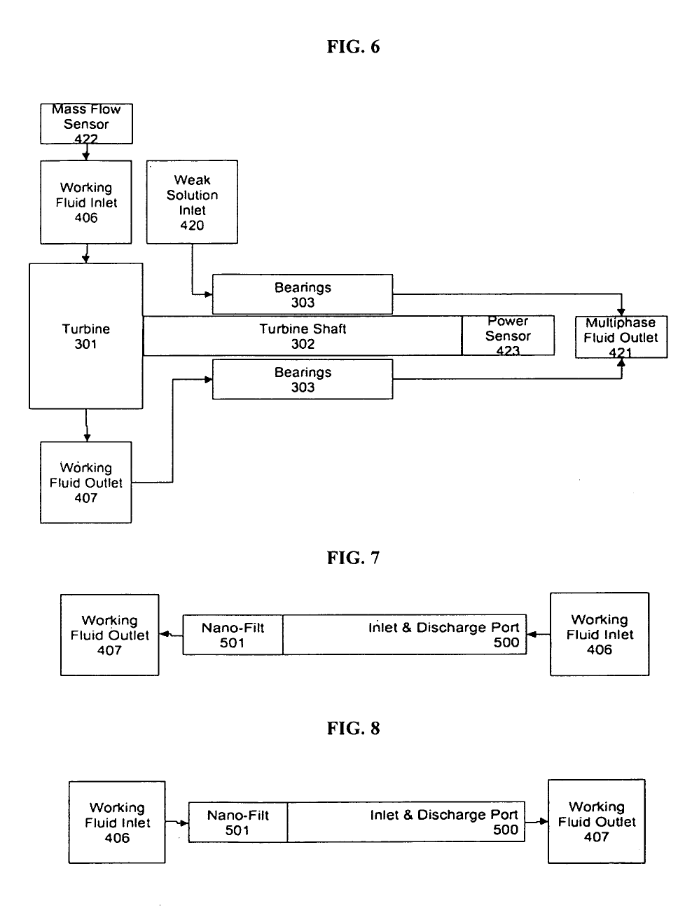

Referring to FIG. 6 is a depiction an expansion device, which is exemplified by the turbine 301, connected by a turbine shaft 302 providing directional stability in conjunction with bearings 303, which can include axial bearings, journal bearings, and/or hydrodynamic bearings. The turbine 301 in this example is utilized to extract mechanical energy resulting from the expansion of a thermodynamic working fluid from an absorption heat pump. An absorption heat pump has three streams of fluid that are the thermodynamic working fluid (i.e., refrigerant), the weak solution (i.e., a relatively lower mass fraction of working fluid absorbed into the absorbent, as compared to the strong solution), and the strong solution (i.e., a relatively higher mass fraction of working fluid absorbed into the absorbent). The weak solution, preferably after the recovery of mechanical energy from the operating high pressure to the operating low pressure, enters the expansion device through the weak solution inlet 420 that then subsequently passes through the bearings 303 to reduce the friction between the moving surfaces. The use of power sensor 423 in conjunction with a mass flow sensor 422 and a lookup table that is a multivariate representation of predicted turbine efficiency as a function of mass flow to identify leak paths beyond the initial design specifications. The thermodynamic working fluid enters the turbine 301 high pressure side through the working fluid inlet 406 downstream of a mass flow sensor 422 to provide actual mass flow. The expanded working fluid is discharged from the turbine 301 through the working fluid outlet 407 that subsequently passes through the bearings 303 at which time the weak solution and the expanded working fluid are intimately mixed by the rotating bearings 303 to accelerate the absorption of the working fluid into the absorbent (i.e., the binary composition of weak solution comprised of absorbent and absorbate) that is finally discharged as a multiphase pre-absorbed strong solution through the multiphase fluid outlet 421.

Referring to FIG. 7 is a depiction of combo inlet and discharge port as provided in a rotating motor or pump. The rotating motor or pump, particularly when operating on compressible fluids must have a combo inlet and discharge port that has minimal volume as compared to the rotating motor or pump cell/chamber in order to minimize the workless expansion. This exemplary use of a combo inlet and discharge port 500 is operating in the inlet mode where the working fluid enters the port 500 through the working fluid inlet 406. The port 500 has at its far end a nanofiltration membrane 501 to prevent the discharge a relatively higher molecular weight lubricant (as compared to the working fluid gas molecular weight). The working fluid is discharged through the working fluid outlet 407.

Referring to FIG. 8 is a depiction of combo inlet and discharge port as provided in a rotating motor or pump. The rotating motor or pump, particularly when operating on compressible fluids must have a combo inlet and discharge port that has minimal volume as compared to the rotating motor or pump cell/chamber in order to minimize the workless expansion. This exemplary use of a combo inlet and discharge port 500 is operating in the discharge mode where the working fluid enters the port 500 through the working fluid inlet 406. The port 500 has at its near end a nanofiltration membrane 501 to prevent the discharge a relatively higher molecular weight lubricant (as compared to the working fluid gas molecular weight). The working fluid is discharged through the working fluid outlet 407.

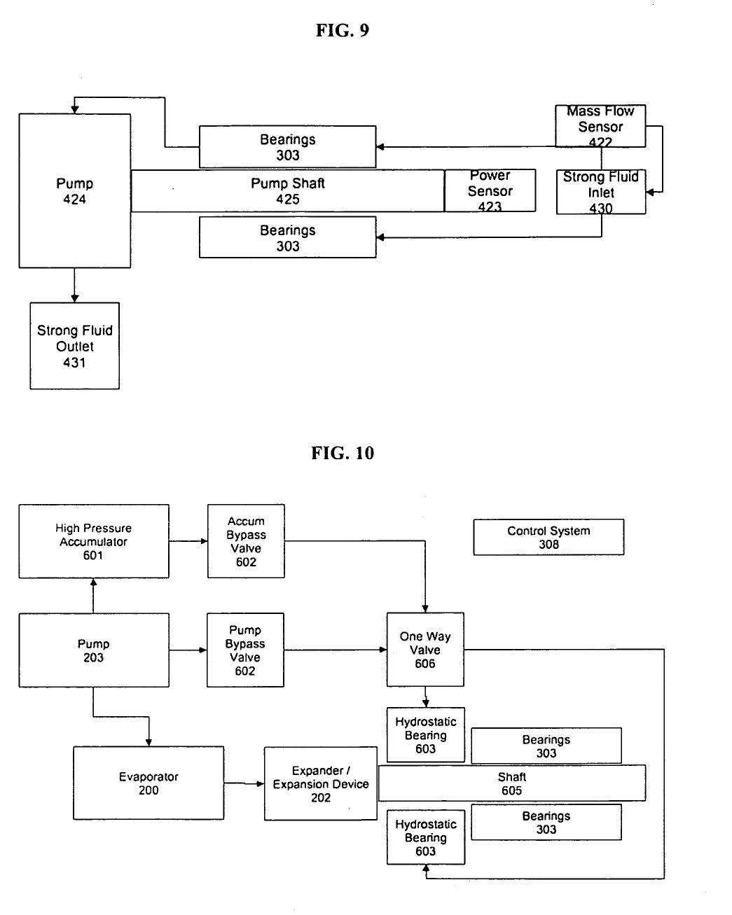

Referring to FIG. 9 is a depiction of pump 424 operating in an absorption heat pump. The pump 424 is connected to a pump shaft 425 stabilized by bearings 303. The strong solution enters the pump strong fluid inlet 430 after passing through a mass flow sensor 422 (sensor is optional, and can also be downstream pump) to measure the actual mass flow, which in combination with the power sensor 423 (that measures actual pump energy consumed) and a lookup table projecting actual energy consumption/efficiency as a multivariate parametric formula to predict an increase in leak paths. The strong solution passes through the bearings 303 as a method to reduce the operating friction between moving parts, in this example being the friction between the pump shaft 425 and the bearings 303. The strong solution then sequentially is pumped from the low pressure to the strong solution being finally discharged through the strong solution outlet 431.

Referring to FIG. 10 is a depiction of pump 203, which increases the pressure of a thermodynamic working fluid into a high-pressure working fluid being the same working fluid that also passes through the expansion device 202. The high-pressure working fluid then subsequently passes into either the high pressure accumulator 601, the evaporator 200, or directly to the one way valve 606 in fluid communication with the hydrostatic bearing 603. The pump will operate and direct the high-pressure working fluid directly to the high-pressure accumulator 601 when necessary to replenish the supply of high pressure working fluid. The pump 203 will operate and direct the high pressure working fluid directly to the one way valve 606, in other words not through the evaporator 200 as traditionally done in a thermodynamic cycle. The high-pressure fluid has a higher density, as compared to a heated fluid, to further reduce the friction of the expander shaft 605 during start up or shut down operations. The pump 203 will operate and direct the high pressure working fluid directly to the evaporator 200 following the termination of the start up sequence at which time the expansion device 202 has reached sufficient speed for the hydrostatic bearing 603 (or magnetic bearing) to “lift” off. The control system 308 regulates the open, close, or variable open position of the pump bypass valve 602 and the accumulator bypass valve 602 to enable the high-pressure working fluid to pass through the one way valve 606 into the expansion device's hydrostatic bearing 603.

One exemplary of the invention is a thermodynamic system comprising a thermodynamic device having at least one moving surface, a lubricant, a thermodynamic working fluid, where the thermodynamic device includes an expansion device (i.e., expander), and pumping (e.g., positive displacement pump) or compressing device (i.e., compressor). The lubricant reduces the friction between moving surfaces by creating hydrostatic and/or hydrodynamic forces through the utilization of the thermodynamic working fluid. The thermodynamic working fluid's temperature, which makes the working fluid an expanded liquid, increases from friction between the moving surface(s). The preferred lubricant is at least partially immiscible with the thermodynamic working fluid and reduces the friction between the moving surface(s) by at least 5 percent of the friction when not using an expanded liquid. An embodiment of the invention achieves a reduction of friction between the moving surfaces of at least 15%, and in the particularly preferred embodiment of virtually eliminating friction between the moving surfaces through the effective creation of a hydrostatic “bearing” where the expanded working fluid's volumetric increase becomes an air cushion.

The particularly preferred thermodynamic working fluid is a binary solution having an absorbate and absorbent where the preferred lubricant absorbs the absorbate at a first pressure P1, a first temperature T1, and a first density D1. The increase in temperature due to the friction of the moving parts increases the lubricant temperature to a second temperature T2 and has a second pressure P2 and second density D2 at which point the lubricant desorbs at least 5 weight percent of the absorbate being the desorbed absorbate. The particularly preferred thermodynamic working fluid absorbent and/or lubricant are both selected from the group consisting of ionic liquids, liquid ionic phosphates, polyammonium ionic liquid sulfonamides, and poly(ionic liquids). It is furthermore preferred that the lubricant is comprised of at least one component identical to the thermodynamic working fluid absorbent. The lubricant will absorb at least 1% by weight of the thermodynamic working fluid in order to create a volumetric expansion at the second temperature T2 in order to further reduce the friction between the moving parts.

It is recognized in the art that lubricants have adverse impact on heat transfer thus the desire to reduce the lubricant content from the thermodynamic working fluid as known in the art using oil separators. The thermodynamic device of the invention also has a separation device, with the at least two heat exchangers (e.g., evaporator, condenser, regenerator) in order to isolate at least 90 percent of the lubricant from the thermodynamic working fluid. The significant reduction of the lubricant from the thermodynamic working fluid enables an increase in heat transfer by at least 5 percent of the at least two heat exchangers. The preferred lubricant has the ability to control the hydrodynamic film thickness by using a lubricant that is electrically conductive. The current art of lubricants is recognized as including the use of additives within either/both the thermodynamic working fluid or lubricant to enhance corrosion protection, increase thermal conductivity (e.g., nanoscale additives), increase electrical conductivity (e.g., nanoscale additives, and potassium salts). The particularly preferred lubricant has the ability to absorb the thermodynamic working fluid at a relatively lower temperature, which then subsequently desorbs at least 0.5% by weight of the thermodynamic working fluid being the desorbed absorbate. One exemplary lubricant is a functionalized lubricant to increase the gas absorption ability to at least 1% on a weight basis such as an ionic liquid containing increased fluoroalkyl chains on either the cation or anion to improve carbon dioxide solubility as compared to less fluorinated ionic liquids. It is recognized in the art that at least one desorption method including electrostatic desorption, electromagnetic desorption, or thermal desorption can be utilized. The specifically preferred lubricant concurrently desorbs at least 0.5% by weight of the thermodynamic working fluid from the lubricant by electrostatic desorption or electromagnetic desorption, and increases the hydrodynamic film thickness by at least 5% through the lubricants electrostatic/electromagnetic attraction to the moving surface. The lubricant operating conditions and molecular composition are selected such that the desorbed absorbate volumetrically expands by at least 3 percent, with a nominal 15 Kelvin temperature change, as a result of the lubricant's temperature rise leading to at least a 10 percent friction reduction as compared to a lubricant not having the ability to absorb then desorb the thermodynamic working fluid (i.e., the desorbed gas is the refrigerant of the thermodynamic system). One such operating condition is where the desorbed absorbate expands to a second density D2 at a second operating pressure P2 (where the pressure P2 is at least 10 psi higher than the first operating pressure P1). The lubricant expansion leads a localized seal to subsequently reduce leak paths and therefore increase isentropic efficiency of the thermodynamic device.

As noted earlier, the presence of the lubricant has an adverse impact on heat transfer, the control system will further regulate a first electrostatic device operable to attract the lubricant to at least one moving surface of the thermodynamic device and a second electrostatic device operable to isolate the lubricant from the thermodynamic working fluid after lubricating the thermodynamic device moving surfaces such that the lubricant is predominantly present during start/stop operations particularly when used with hydraulic motors such as positive displacement motors, radial thermodynamic devices selected from power producing devices such as turbines, turboexpanders, and ramjets, or power consuming devices including air compressors, vacuum pumps, fuel pumps, fluid pumps, hydraulic pumps, and positive displacement pumps. An exemplary second electrostatic device is an electrostatic filter, an electrode, or an electrostatic membrane. And an exemplary first electrostatic device is an electrode, a porous electrode or an electrostatic membrane.

Another embodiment of the invention is the use of the high pressure thermodynamic working fluid and a control system controlling a high pressure valve to regulate the passage of the high pressure thermodynamic working fluid into the thermodynamic device's moving surfaces to create a hydrostatic force. Of particular importance is the utilization of the high pressure fluid to create a hydrostatic force prior to the thermodynamic device's achieving sufficient speed to utilize hydrostatic air bearings/air foils as known in the art. The release of the thermodynamic working fluid from the thermodynamic working fluid high pressure accumulator creates a hydrostatic force, thus operating as a hydrostatic bearing to reduce by at least 50% the dry running friction between moving surfaces of the thermodynamic device. The preferred control system utilizes a variable position high pressure valve to dynamically regulate the working fluid flow such that the combination of the hydrostatic force from the fluid and the real-time speed of the thermodynamic device creating a second hydrostatic force from the hydrostatic air bearing/air foil is precisely the force required to prevent direct contact of the moving surfaces. One exemplary operating mode is where the thermodynamic working fluid high pressure accumulator provides mass flow prior to equilibrium operation to create a hydrostatic force on the hydrostatic bearing until the thermodynamic device is operating at sufficient speed to reduce by at least 10%, with typically at least 50%, and optimally virtually eliminating the dry running friction between moving surfaces. The invention anticipates the utilization of a magnetic bearing as known in the art in replacement of the air bearings/air foil, where air and gas are interchangeable.

Another embodiment of the invention is the combination of the particularly preferred lubricant, which is electrically conductive, and a membrane that is preferably a nanofiltration membrane. The specifically preferred nanofiltration membrane has a pore size that is at least 5% smaller than the lubricant molecular size, and at least 5% greater than the thermodynamic working fluid molecular size. Alternatively, the membrane can have a pore size that is larger than the working fluid molecular size and has a thickness that is at least 10 times the molecular size of the working fluid, thus creating a tortuous path to limit the flow of the thermodynamic working fluid. The membrane contains the lubricant that when configured within a pipe is controlled to limit and/or prevent the flow of the thermodynamic working fluid. The configuration is effectively a valve, which when configured with a controllable electrostatic or electromagnetic field limits the flow thermodynamic working fluid through the membrane. The control system switches the electrostatic device to attract and or repel the lubricant. The configuration within the valve determines whether the electrostatic film blocks the flow of working fluid, or opens the passage to enable flow of working fluid. The control system varies the electrostatic device operating voltage to dynamically vary the thermodynamic working fluid flow rate through the valve.

Another embodiment of the invention is the utilization of the strong solution, from within an absorption heat pump system to reduce the friction created from moving surfaces of the pump, through the pump where it concurrently increases the enthalpy of the strong solution due to the thermal energy from friction within the pump and reduces friction.

Yet another embodiment, is a friction reducing machine having at least one moving surface, a fluid port that is operational as both the fluid inlet and discharge outlet, and a nanofiltration membrane within the fluid port to contain a lubricant. The nanofiltration membrane contains the lubricant within the cell/cavity of the machine by minimizing the discharge of the lubricant by selectively enabling a working fluid having a smaller molecular weight to discharge from the machine. A preferred configuration utilizes an electrostatic field to increase the hydrodynamic film within the machine further reducing the friction. A preferred machine includes gerotor motor, gerotor pump, vane motor, vane pump, piston motor, and piston pump, which can be operational as hydraulic pumps/motors or equally well using a fluid medium selected from water, air, fuel, refrigerants, etc. It is anticipated that the configuration further comprising the mass flow sensor and power sensor is also utilized in the aforementioned machine by utilizing a control system having a machine performance table. The control system has a performance table that is ideally represented as known in the art by a multi-parametric non-linear equation that is a function of input temperature, input pressure, outlet temperature, outlet pressure, and mass flow. The machine's real-time performance is compared to the predicted power output from the multi-parametric equation to predict scheduled maintenance requirements. The particularly preferred machine is manufactured of at least one part that has the moving surface such that the part is able to wear into its final size in order to minimize leak paths between the moving surfaces. It is recognized in the art that the part can be made of a soft metal, ceramic, or carbon/graphite where the part is machined to a size that is at least 0.0005 inches larger than final part size.

The invention has been described with reference to the various preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A thermodynamic system comprising a thermodynamic device, a lubricant, a thermodynamic working fluid, the thermodynamic device having moving surfaces operable to create both hydrostatic and hydrodynamic forces, wherein the thermodynamic working fluid temperature increases from friction of the thermodynamic device, wherein the lubricant is at least partially immiscible with the thermodynamic working fluid and is operable to reduce friction at least 10 percent through the hydrostatic force within the thermodynamic device.

2. The thermodynamic system according to claim 1, wherein the thermodynamic working fluid is further comprised of the lubricant operable to absorb an absorbate having a first pressure P1, a first temperature T1, and a first density D1, wherein the lubricant temperature increases to a second temperature T2 and has a second pressure P2 and second density D2, wherein the lubricant at the second temperature T2 desorbs at least 5 weight percent of the absorbate being the desorbed absorbate.

3. The thermodynamic system according to claim 1 wherein the thermodynamic device is selected from the group consisting of a compressor, expander, or pump.

4. The thermodynamic system according to claim 1 wherein the thermodynamic working fluid absorbent and the lubricant are both selected from the group consisting of ionic liquids, liquid ionic phosphates, polyammonium ionic liquid sulfonamides, and poly(ionic liquids).

5. The thermodynamic system according to claim 1 wherein the thermodynamic lubricant is selected from the group consisting of ionic liquids, liquid ionic phosphates, polyammonium ionic liquid sulfonamides, and poly(ionic liquids), wherein the thermodynamic lubricant absorbs at least 1% by weight of the thermodynamic working fluid.

6. The thermodynamic system according to claim 1 further comprising at least two heat exchangers and a separation device to isolate at least 90 percent of the lubricant from the thermodynamic working fluid operable to increase heat transfer by at least 5 percent of the at least two heat exchangers.

7. The thermodynamic system according to claim 1 further comprising a hydrostatic bearing, a thermodynamic working fluid high pressure accumulator, and a control system having at least one working fluid high pressure valve, wherein the control system controls the at least one working fluid high pressure valve to allow passage of the thermodynamic working fluid from the thermodynamic working fluid high pressure accumulator operable to create a hydrostatic force on the hydrostatic bearing to reduce by at least 50% the dry running friction between moving surfaces of the thermodynamic device.

8. The thermodynamic system according to claim 5 wherein the lubricant desorbs at least 0.5% by weight of the thermodynamic working fluid being the desorbed absorbate from the lubricant by at least one desorption method including electrostatic desorption, electromagnetic desorption, or thermal desorption.

9. The thermodynamic system according to claim 5 wherein the lubricant desorbs at least 0.5% by weight of the thermodynamic working fluid from the lubricant by electrostatic desorption or electromagnetic desorption, and wherein the electrostatic or electromagnetic field concurrently increases the hydrodynamic film thickness by at least 5%.

10. The thermodynamic system according to claim 5 further comprised of a first electrostatic device operable to attract the lubricant to at least one moving surface of the thermodynamic device and a second electrostatic device operable to isolate the lubricant from the thermodynamic working fluid after lubricating the thermodynamic device moving surfaces.

11. The thermodynamic system according to claim 7 wherein the control system regulates the thermodynamic working fluid from the thermodynamic working fluid high pressure accumulator operable to balance the real-time load on the hydrostatic bearing.

12. The thermodynamic system according to claim 7 further comprised of at least one bearing selected from the group of gas bearing, air foil bearing, or magnetic bearing, wherein the control system regulates the thermodynamic working fluid from the thermodynamic working fluid high pressure accumulator operable to create a hydrostatic force on the hydrostatic bearing until the thermodynamic device is operating at a speed whereby the bearing creates a hydrostatic or magnetic force to reduce by at least 50% the dry running friction between moving parts of the thermodynamic device.

13. The thermodynamic system according to claim 8 wherein the desorbed absorbate volumetrically expands by at least 3 percent creating a hydrostatic force and is operable to reduce friction of the moving surfaces by at least 10 percent greater than the lubricant without desorbed absorbate.

14. The thermodynamic system according to claim 8 wherein the desorbed absorbate expands to the second density D2 and is operable to create a second operating pressure P2 and a localized seal to reduce leak paths, and wherein pressure P2 is at least 10 psi higher than the first operating pressure P1.

15. The thermodynamic system according to claim 8 wherein the desorbed absorbate is operable as a refrigerant in a thermodynamic cycle.

16. The thermodynamic system according to claim 13 wherein the second electrostatic device is selected from the group consisting of an electrostatic filter, an electrode, or an electrostatic membrane.

17. The thermodynamic system according to claim 13 wherein the first electrostatic device is selected from the group consisting of an electrode, a porous electrode or an electrostatic membrane.

18. A thermodynamic system comprising a thermodynamic device having at least one moving surface, a thermodynamic working fluid, a lubricant, a first electrostatic device operable to attract the lubricant to the at least one moving surface of the thermodynamic device, and a second electrostatic device, operable to isolate the lubricant from the thermodynamic working fluid after lubricating the thermodynamic device moving surfaces.

19. The thermodynamic system according to claim 18 further comprising an expansion device, wherein the expansion device is upstream of the second electrostatic device.

20. The thermodynamic system according to claim 18 further comprising a heat exchanger device, wherein the heat exchanger device is downstream of the second electrostatic device.

21. A thermodynamic system comprising a thermodynamic device having at least one moving surface, a thermodynamic working fluid, a lubricant, a first electrostatic device having at least two modes of operation including the mode of attracting the lubricant to the at least one moving surface or the mode of repelling the lubricant from the at least one moving surface.

22. The thermodynamic system according to claim 21 further comprising a temperature sensor to measure the lubricant temperature.

23. The thermodynamic system according to claim 21 further comprising a control system, a lubricant injection device, and a switching device to reverse the polarity of the electrostatic device, wherein the control system is operable to switch the polarity of the electrostatic device between the operating mode of attracting the lubricant and repelling the lubricant from the at least one moving surface.

24. The thermodynamic system according to claim 21 further comprising at least one friction reducing device operable to reduce friction of the at least one moving surface by at least 10 percent wherein the at least one friction reducing device includes gas bearings, gas foil bearings, and magnetic bearings.

25. The thermodynamic system according to claim 21 further comprising a membrane operable to contain the lubricant and to pass the thermodynamic working fluid.

26. The thermodynamic system according to claim 23 wherein the control system is operable to switch the electrostatic device to attract the lubricant when the at least one friction reducing device is operating at a speed at least 50 percent less than the thermodynamic device operating speed, and to repel the lubricant when the at least one friction reducing device is operating at a speed at least 50 percent of the thermodynamic device operating speed.

27. The thermodynamic system according to claim 26 wherein the control system is operable to switch the electrostatic device to attract the lubricant and to limit the flow of the thermodynamic working fluid operable as a flow control valve.

28. The thermodynamic system according to claim 26 wherein the control system is operable to switch the electrostatic device to repel the lubricant and to limit the flow of the thermodynamic working fluid operable as a flow control valve.

29. The thermodynamic system according to claim 26 wherein the control system varies the electrostatic device by dynamically changing the electrostatic device operating voltage operable to vary the thermodynamic working fluid flow rate.

30. A thermodynamic system comprising a thermodynamic device having at least one moving surface, a thermodynamic working fluid and a lubricant, wherein the thermodynamic working fluid is an expanded fluid wherein the expanded fluid has a decreasing density of at least 3 percent for an increase in temperature of at least 15 Kelvin and is operable to reduce friction of the at least one moving surface.

31. The thermodynamic system according to claim 30 wherein the lubricant is an absorbent of the thermodynamic working fluid.

32. The thermodynamic system according to claim 30 further comprised of an electrostatic device operable to concurrently attract the lubricant to the at least one moving surface and to at least partially desorb the thermodynamic working fluid from the absorbent.

33. A thermodynamic system comprising a thermodynamic device having at least one moving surface, a thermodynamic working fluid, a lubricant, and an electrostatic or electromagnetic device, wherein the thermodynamic working fluid is a binary fluid having an absorbate and an absorbent, wherein the lubricant is electrically conductive, and wherein the lubricant concurrently increases lubricity by at least 5 percent of the at least one moving surface and increases desorption of the absorbate from the absorbent.

34. The thermodynamic system according to claim 33 further comprised of an electrical or magnetic field operable to increase the desorption of the absorbate from the thermodynamic working fluid.

35. The thermodynamic system according to claim 33 further comprised of an electrical or magnetic field operable to increase the absorption of the absorbate from the thermodynamic working fluid.

36. The thermodynamic system according to claim 33, wherein the lubricant is comprised of at least one compound selected from the group consisting of ionic liquids, liquid ionic phosphates, polyammonium ionic liquid sulfonamides, poly(ionic liquids) and expanded fluid.

37. A thermodynamic device comprising a thermodynamic device having at least one moving surface, a thermodynamic working fluid, a lubricant, a nanofiltration membrane, and an electrostatic or electromagnetic device, wherein the thermodynamic working fluid is capable of passing through the nanofiltration membrane, wherein the lubricant is electrically conductive or magnetic, and wherein the electrostatic or electromagnetic device is operable to attract or repel the lubricant within the nanofiltration membrane as a means to control the passing of the thermodynamic working fluid through the nanofiltration membrane.

38. The thermodynamic system according to claim 37, wherein the nanofiltration membrane has a pore size that is at least 5% smaller than the lubricant molecular size, and at least 5% greater than the thermodynamic working fluid molecular size.

39. The thermodynamic system according to claim 37, wherein the lubricant is at least one selected from the group consisting of ionic liquids, liquid ionic phosphates, polyammonium ionic liquid sulfonamides, poly(ionic liquids), and electrorheological fluids.

40. A lubricant, comprising an absorbent having a gas absorption of at least 0.5% on a weight basis and having a gas desorption being desorbed gas of at least 0.25% on a weight basis when applied to at least one moving surface operable to reduce friction by utilizing the desorbed gas to reduce the physical contact between the at least one moving surface.

41. The lubricant according to claim 40 further comprising an electrostatic field, wherein the electrostatic field causes a gas desorption of at least 0.25% on a weight basis.

42. The lubricant according to claim 40 further comprising an electrostatic field, wherein the electrostatic field causes the concurrent gas desorption of at least 0.25% on a weight basis and an increase in hydrodynamic film thickness through electrostatic attraction of the absorbent to the at least one moving surface.

43. The lubricant according to claim 40 wherein the lubricant is applied to the at least one moving surface of a power producing or power consuming devices including air compressors, vacuum pumps, fuel pumps, fluid pumps, hydraulic pumps, hydraulic motors, turbines, positive displacement pumps, and positive displacement motors.

44. The lubricant according to claim 40 wherein the lubricant is functionalized to increase the gas absorption ability to at least 1% on a weight basis.

45. The lubricant according to claim 42 further comprised of a temperature sensor in thermal communication with the lubricant and a reservoir of cooled lubricant operable to switch the electrostatic field to repel the lubricant when the lubricant exceeds a maximum temperature threshold sequentially followed by a switch in polarity of the electrostatic field to attract the lubricant from the reservoir of cooled lubricant.

46. A thermodynamic system comprising thermodynamic device having at least one moving surface, a binary thermodynamic working fluid, wherein the thermodynamic device is an absorption heat pump comprised of a weak solution, and a strong solution, wherein the strong solution has an absorbate, and wherein the weak solution or strong solution is operable as a friction reducing lubricant.

47. The thermodynamic system according to claim 46 further comprising an expansion device having at least one moving surface, wherein the weak solution is mixed with the thermodynamic working fluid after being expanded through the expansion device within the at least one moving surface operable as a friction reducing lubricant while concurrently increasing absorption of the thermodynamic working fluid by the weak solution due to the mixing within the expansion device.

48. The thermodynamic system according to claim 46 further comprising a pump having friction producing moving parts, wherein the strong solution after passing through the pump is mixed within the at least one moving surface operable as a friction reducing lubricant while concurrently increasing enthalpy of the strong solution due to the thermal energy from friction within the pump.

49. A friction reducing machine comprised of at least one moving part, a friction reducing lubricant, a fluid port that is operational as both the fluid inlet and discharge outlet, and a nanofiltration membrane within the fluid port, wherein the nanofiltration membrane is operable to contain the friction reducing lubricant within the at least one moving surface of the friction reducing machine.

50. The friction reducing machine according to clam 49 further comprised of an electrostatic field wherein the electrostatic field is operable to increase the hydrodynamic film between the at least one moving surface.

51. The friction reducing machine according to claim 49 wherein the friction reducing machine is a device selected from the group consisting of a gerotor motor, gerotor pump, vane motor, vane pump, piston motor, and piston pump.

52. A thermodynamic system comprising a thermodynamic device having at least one moving surface, a thermodynamic working fluid, an expansion device having a hydrostatic bearing, a high pressure side wherein the high pressure side is upstream of the expansion device, at least one valve controlling the flow of the thermodynamic working fluid into the expansion device, at least one valve controlling the flow of the thermodynamic working fluid into the hydrostatic bearing, a thermodynamic working fluid high pressure accumulator, and a control system wherein the control system regulates the at least one valve controlling the flow of the thermodynamic working fluid into the expansion device and the at least one valve controlling the flow of the thermodynamic working fluid into the hydrostatic bearing from the thermodynamic working fluid high pressure accumulator operable to create a hydrostatic force on the hydrostatic bearing to reduce by at least 50% the dry running friction between moving parts of the expansion device.

53. The thermodynamic system according to claim 52 further comprising a pumping or compressing device having a hydrostatic bearing, at least one valve controlling the flow of the thermodynamic working fluid into the pumping or compressing device, at least one valve controlling the flow of the thermodynamic working fluid into the pumping or compressing device hydrostatic bearing wherein the control system regulates the at least one valve controlling the flow of the thermodynamic working fluid into the pumping or compressing device and the at least one valve controlling the flow of the thermodynamic working fluid into the pumping or compressing hydrostatic bearing from the thermodynamic working fluid high pressure accumulator operable to create a hydrostatic force on the pumping or compressing hydrostatic bearing to reduce by at least 50% the dry running friction between moving parts of the pumping or compressing device.

54. The thermodynamic system according to claim 52 wherein the control system regulates the thermodynamic working fluid from the thermodynamic working fluid high pressure accumulator operable to balance the real-time load on the hydrostatic bearing.

55. The thermodynamic system according to claim 52 further comprised of at least one bearing selected from the group of gas bearing, air foil bearing, or magnetic bearing, wherein the control system regulates the thermodynamic working fluid from the thermodynamic working fluid high pressure accumulator operable to create a hydrostatic force on the expansion device hydrostatic bearing until the expansion device is operating at a speed whereby the at least one bearing creates a hydrostatic or magnetic force to reduce by at least 50% the dry running friction between moving parts of the thermodynamic device.
